(19) United States
(12) Patent Application Publication
(10) Pub. No.: US 2008/0005806 A1
(43) Pub. Date: Jan. 3, 2008

(54) Apparatus, network entity and associated methods and computer program products for selectively enabling features subject to digital rights management

(75) Inventor: Jukka Alve, Vantaa (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/480,202

(22) Filed: Jun. 30, 2006

(51) Int. Cl. G06F 17/30

(52) U.S. Cl. 726/30

(57) ABSTRACT

An apparatus, network entity, methods and computer program products are provided for selectively enabling one or more features subject to digital rights management (DRM) based upon communication between a mobile station or other end user apparatus and a network entity. By permitting selective enablement, end users need not pay for features that are not employed. However, a manufacturer can incorporate the same plurality of features into each apparatus so as to thereby effectively have a universal model of the apparatus which may be customized by the user with only selected features enabled with the others remaining disabled.

### FIELD OF THE INVENTION

Embodiments of the present invention relate generally to the selective enablement of features by an apparatus, such as a mobile station and, more particularly, to an apparatus, network entities and associated methods and computer program products for selectively enabling features that are subject to digital rights management.

### BACKGROUND OF THE INVENTION

Historically, the number of features that could be included in a mobile station, such as a mobile telephone, a portable digital assistant (PDA), a pager, a laptop computer, a mobile gaming device and other types of mobile electronic systems, was limited by the storage capacity or other hardware restrictions imposed by the mobile station. In recent years, however, the size and cost of integrated circuitry has significantly decreased with the size of at least some integrated circuits now governed by the pin count as opposed to the number of logic gates or transistors included within the integrated circuit. By way of example, Moore's law posits that the number of transistors per square inch in an integrated circuit will double every year, while a corollary to Moore's law posits that data density in integrated circuits will double every 18 months.

Since the integrated circuits utilized by modern mobile stations can include so many different features it has become difficult for the manufacturers and other suppliers of mobile station to determine which subset of the features to include in a particular mobile station. In this regard, some end users may desire a first set of features while having no interest in any other features. Conversely, another group of end users may desire only a second set of features that differs from the first set of features. In order to satisfy all of the disparate preferences of the potential end users, manufacturers and other suppliers of mobile stations are tempted to incorporate all of the possible features in a mobile station since the storage and other hardware limitations are no longer as much of an impediment.

However, many features are commonly proprietary to a third party, such as the party originating the feature. As such, many features are protected intellectual property rights such as patent rights, copyright rights or the like and are therefore subject to digital rights management (DRM). he parties which own the various features and the corresponding intellectual property rights may license use of the features and the intellectual property rights embodied therein in exchange for a fee or royalty. Since the incorporation of features into a mobile station commonly comes with a cost, i.e., the fee or royalty levied by the owner of the feature and the corresponding intellectual property rights, the cost of a mobile station that includes all or a large number of the possible features may quickly become prohibitive, at least to the majority of potential end users. In this regard, while a few end users may expect to be prolific in their use of the mobile station and to employ the vast majority, if not all, of the features and may therefore be willing to pay the relatively high price of such a mobile station, the majority of the end users likely will only utilize a subset of the possible features and therefore be reluctant to pay the relatively high price for a mobile station that includes all of the possible features including numerous features which the end users will not utilize. As noted above, however, the determination as to which features to include in the mobile station in order to reduce that portion of the costs of the mobile station to the minimum required to obtain the necessary rights in the features desired by the end users is complicated since different end users desire different feature sets.

In order to reduce the fees that must be paid to obtain the necessary rights in features that will be of interest to only some of the end users, devices have been designed to include the various features in the hardware, but to permit the features to be selectively enabled or disabled prior to delivery of the device to the end user. Since the fees for rights in the features would only be paid for those features that were enabled prior to deliver of the device to the end user and not for those features that were disabled, that portion of the cost of the device attributable to the fees that must be paid to obtain the necessary rights in the features can be minimized. For example, one approach utilized in conjunction with the circuitry employed in set top boxes has been to include the circuitry required for analog copy protection in the chip set, but then to appropriately configure the set top box during manufacture so as to only utilize the copy protection circuitry in instances in which such copy protection is desirable. For example, while analog copy protection is desired on some instances, analog copy protection is not desired in free-to-air set top boxes. During manufacture of the set top boxes, the analog copy protection circuitry is either enabled or disabled through the use of different software, bond wires, programmable fuses, etc. While this approach is effective in allowing a set top box manufacturer to purchase common circuitry and to then appropriately enable or disable the circuitry required for analog copy protection at the time of manufacture of the set top box, the enablement or disablement of the analog copy protection feature is made in a permanent manner at the time of manufacture and does not permit the end user to enable or disable the analog copy protection feature once the set top box has been delivered.

As such, an improved technique for selectively enabling features that are subject to DRM is desirable. In particular, it would be desirable to provide an improved technique for enabling features subject to DRM following manufacture of the device, such as in response to selection of various feature(s) by the end user.

### BRIEF SUMMARY OF THE INVENTION

In light of the foregoing background, exemplary embodiments of the present invention provide an improved apparatus, network entity, methods and computer program products for selectively enabling one or more features subject to digital rights management (DRM) based upon communication between a mobile station or other end user apparatus and a network entity. By permitting selective enablement, end users need not pay for features that are not employed. Nonetheless, a manufacturer can incorporate the same plurality of features into each apparatus so as to thereby effectively have a universal model of the apparatus which may be customized by the user with only selected features enabled with the others remaining disabled.

In one embodiment, an apparatus, such as a mobile station, is provided that includes a processing element configured to receive input indicative of a respective disabled feature, to issue a request, such as to a network entity, for a DRM rights object for the respective feature, to receive the DRM rights object for the respective feature and to enable the respective feature in response to receipt of the DRM rights object. The apparatus, such as a mobile station, may also include a memory device for storing at least one disabled feature that is subject to DRM. The processing element may be configured to receive the input indicative of the disabled feature to be enabled in various manners. For example, the processing element may be configured to receive input indicative of an attempt to access the respective feature and to interpret such an attempt as a request for enablement. In this regard, the processing element may be configured to issue the request for the DRM rights object automatically in response to receipt of input indicative of an attempt to access a respective feature. The processing element may also be configured to receive input indicative of a request for enablement of the respective feature by receiving payment authorization from the user in exchange for the DRM rights object.

In one embodiment, the processing element is configured to support first and second types of DRM with the first type of DRM being currently enabled and the second type of DRM being currently disabled. In this embodiment, the processing element may be configured to receive input indicative of the second type of DRM and to issue a request for a DRM rights object in accordance with the first type of DRM for the second type of DRM. The processing element of this embodiment may receive the DRM rights object in accordance with the first type of DRM for the second type of DRM and may thereafter enable the second type of DRM in response to the receipt of the corresponding DRM rights object.

In one embodiment, the processing element is further configured to determine if intellectual property rights in the respective feature are in existence in the geographic location in which the apparatus is currently operating. If, but only if, the apparatus determines that intellectual property rights are in existence for the respective feature in the geographic location in which the apparatus is currently operating does the mobile station of this embodiment then receive the DRM rights object for the respective feature. In addition to or instead of such geographically limited rights, the feature may be subject to temporally limited rights such that a determination is made of what, if any, intellectual property rights are in existence at the present time. In this regard, the DRM rights object that is received may be configured to only enable the respective feature for a predetermined period of time such that additional requests (and payments) must be made to obtain DRM rights objects for subsequent periods of time.

In one embodiment, the processing element may be configured to determine if any intellectual property rights are embodied in the respective feature in response to receipt of input indicative of the respective feature in order to determine if a DRM rights object has been previously received for each intellectual property right embodied in the respective feature. If, but only if, the DRM rights object for each intellectual property right in the respective feature has not been previously received does the apparatus then receive each DRM rights object that has not been previously received.

On the network side, a network entity is provided in accordance with one embodiment for the present invention which includes a processing element configured to receive a request from an apparatus, such as a mobile station, for a DRM rights object for a respective feature that is stored locally by the apparatus but that is currently disabled. The processing element of the network entity of this embodiment is further configured to transmit the DRM rights object for the respective feature to the mobile station to permit enablement of the respective feature and to note transmission of the DRM rights object for the respective feature. The processing element of the network entity may receive the request by receiving payment authorization from the apparatus in exchange for the DRM rights object in the respective feature.

In one embodiment in which the apparatus supports the first and second types of DRM with a first type of DRM being currently enabled and the second type of DRM being currently disabled, the processing element of the network entity may also be configured to receive a request for the DRM rights objects for the second type of DRM and to transmit the DRM rights object in accordance with the first type of DRM for the second type of DRM.

The processing element of the network entity may be configured to determine if intellectual property rights in the respective feature are in existence in the geographic location which the apparatus is currently operating and, only if so, to transmit the DRM rights object for the respective feature. The processing element may also be configured to determine any intellectual property rights embodied in the respective feature in response to receipt of the request and to thereafter determine if a DRM rights object has been previously transmitted to the apparatus for each intellectual property right embodied in the respective feature. If not, the processing element of the network entity may transmit the DRM rights object for each intellectual property right in the respective feature for which a DRM rights object has not been previously transmitted.

According to other aspects of the present invention, methods and a computer program product are provided for providing selective enablement of feature(s) that are subject to DRM. As such, an end user can selectively enable and therefore selectively choose to pay the fees associated with the feature(s) that are of interest to the end user without unnecessarily increasing the overall cost of the apparatus by including feature(s) that are not of interest to the end user and for which the associated fees are otherwise built into the overall price of the device.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of one type of mobile station and system that would benefit from exemplary embodiments of the present invention;

FIG. 2 is a block diagram of a network entity in accordance with exemplary embodiments of the present invention;

FIG. 3 is a schematic block diagram of an apparatus, such as a mobile station, in accordance with exemplary embodiments of the present invention;

FIG. 4 is a flowchart illustrating various operations of a method of selectively enabling features subject to DRM in accordance with one exemplary embodiment of the present invention;

FIG. 5 is a flow chart illustrating operations of a method according to one embodiment of the present invention; and

FIG. 6 is a flow chart illustrating operations of a method according to another embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

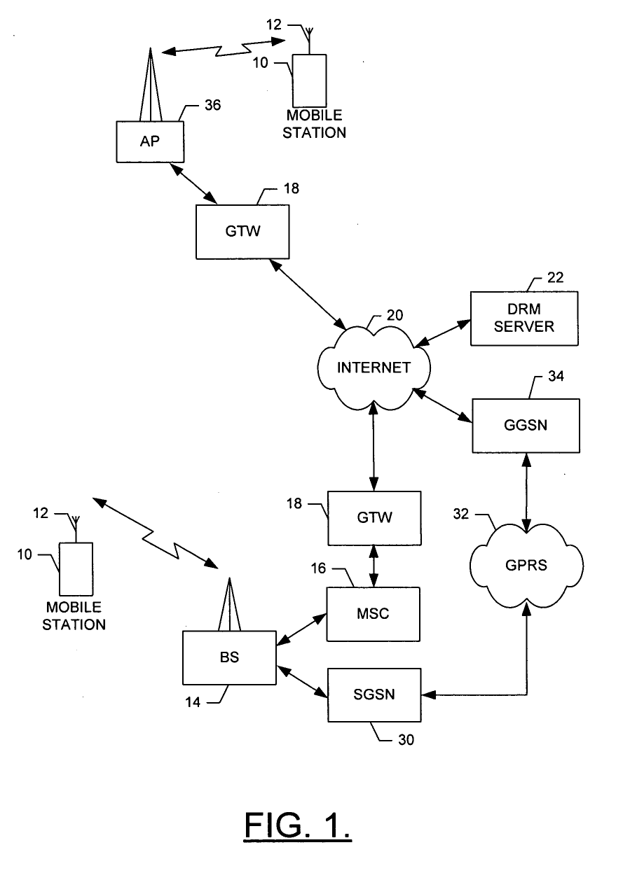

Referring to FIG. 1, an illustration of one type of system that would benefit from embodiments of the present invention is provided. The mobile station, network entity, apparatus, method and computer program product of exemplary embodiments of the present invention will be primarily described in conjunction with mobile communications applications. It should be understood, however, that other embodiments of the present invention can be utilized in conjunction with a variety of other applications, both in the mobile communications industries and outside of the mobile communications industries. For example, embodiments of the present invention can be utilized in conjunction with wireline and/or wireless network (e.g., Internet) applications.

The system can include one or more mobile stations 10, each having an antenna 12 for transmitting signals to and for receiving signals from one or more base stations (BS's) 14, one of each being shown in FIG. 1. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one exemplary embodiment, however, the MSC is coupled to a Gateway (GTW) 18, and the GTW is coupled to a WAN, such as the Internet 20. In turn, network entities 22, such as DRM servers that are typically embodied by one or more server computers can be coupled to the mobile station 10 via the Internet.

The BS 14 can also be coupled to a Serving GPRS (General Packet Radio Service) Support Node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical exemplary embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from exemplary embodiments of the present invention, as should dual or higher mode mobile stations (e.g., digital/analog or TDMA/CDMA/analog phones).

One or more mobile stations 10 (as well as one or more processing elements, although not shown as such in FIG. 1) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including WLAN techniques. The APs may be coupled to the Internet 20. Like with the MSC 14, the AP's can be directly coupled to the Internet. In one exemplary embodiment, however, the APs are indirectly coupled to the Internet via a GTW 18. As will be appreciated, by directly or indirectly connecting the mobile stations and the network entities, such as the DRM servers 22, the mobile stations and network entities can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with exemplary embodiments of the present invention. Thus, use of any such terms should not be taken to limit the spirit and scope of the present invention.

Although not shown in FIG. 1, in addition to or in lieu of coupling the mobile stations 10 to network entities, such as DRM servers 22, across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques.

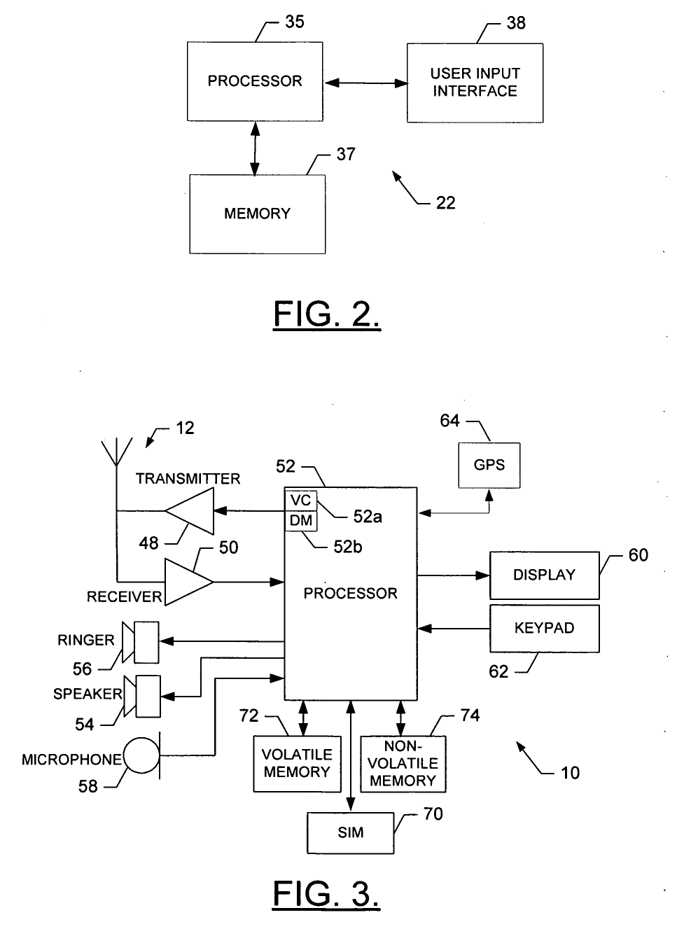

Referring now to FIG. 2, a block diagram of a network entity, such as a DRM server 22, is shown in accordance with one embodiment of the present invention. The network entity includes various means for performing one or more functions in accordance with exemplary embodiments of the present invention, including those more particularly shown and described herein. It should be understood, however, that the network entity may include alternative means for performing one or more like functions, without departing from the spirit and scope of the present invention. More particularly, for example, as shown in FIG. 2, the entity can include a processing element 35 connected to a memory 37. It is understood that the processing element 35 includes the circuitry required for implementing the logic functions of the network entity. For example, the processing element may be comprised of a digital signal processor device, a microprocessor device, and various analog-to-digital converters, digital-to-analog converters, and other support circuits.

The memory 37 can comprise volatile and/or non-volatile memory, and typically stores content, data or the like. For example, the memory typically stores content transmitted from, and/or received by, the network entity. Also for example, the memory typically stores applications, instructions or the like for enabling the processing element 35 to perform steps associated with operation of the network entity in accordance with embodiments of the present invention. In this regard, the application(s) may each comprise software operated by the respective entities. It should be understood, however, that any one or more of the applications can alternatively comprise firmware or hardware, without departing from the spirit and scope of the present invention.

In addition to the memory 37, the processing element 35 can also be connected to at least one interface or other means for displaying, transmitting and/or receiving data, content or the like. In this regard, the interface(s) can include at least one communication interface 38 or other means for transmitting and/or receiving data, content or the like.

Reference is now made to FIG. 3, which illustrates one type of apparatus, a mobile station 10 and, more particularly, a mobile telephone, which would benefit from exemplary embodiments of the present invention. It should be understood, however, that the mobile station illustrated and hereinafter described is merely illustrative of one type of mobile station that would benefit from the present invention and, therefore, should not be taken to limit the scope of the present invention. While several exemplary embodiments of the mobile station will be hereinafter described for purposes of example, other apparatus including other types of mobile stations, such as portable digital assistants (PDAs), pagers, laptop computers, mobile gaming devices and other types of electronic systems, can readily employ embodiments of the present invention.

The mobile station 10 includes various means for performing one or more functions in accordance with exemplary embodiments of the present invention, including those more particularly shown and described herein. It should be understood, however, that the mobile station may include alternative means for performing one or more like functions, without departing from the spirit and scope of the present invention. More particularly, for example, as shown in FIG. 3, in addition to an antenna 12, the mobile station can include a transmitter 48, receiver 50, and processing element 52 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first generation (1G), second generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Also, for example, the mobile station may be capable of operating in accordance with 2.5G wireless communication protocols GPRS, EDGE, or the like. Further, for example, the mobile station may be capable of operating in accordance with 3G wireless communication protocols such as UMTS network employing WCDMA radio access technology. Some NAMPS, as well as TACS, mobile stations may also benefit from the teaching of this invention, as should dual or higher mode phones (e.g., digital/analog or TDMA/CDMA/analog phones).

It is understood that the processing element 52 includes the circuitry required for implementing the audio and logic functions of the mobile station 10. For example, the processing element may be comprised of a digital signal processor device, a microprocessor device, and various analog-to-digital converters, digital-to-analog converters, and other support circuits. The control and signal processing functions of the mobile station are allocated between these devices according to their respective capabilities. The processing element can additionally include an internal voice coder (VC) 52a, and may include an internal data modem (DM) 52b. Further, the processing element may include the functionality to operate one or more software programs which may be stored in memory (described below).

The mobile station 10 also comprises a user interface including a conventional earphone or speaker 54, a ringer 56, a microphone 58, a display 60, and a user input interface, all of which are coupled to the processing element 52. Although not shown, the mobile station can include a battery for powering the various circuits that are required to operate the mobile station, as well as optionally providing mechanical vibration as a detectable output. The user input interface, which allows the mobile station to receive data, can comprise any of a number of devices allowing the mobile station to receive data, such as a keypad 62, a touch display (not shown), a joystick (not shown) or other input device. In exemplary embodiments including a keypad, the keypad includes the conventional numeric (0-9) and related keys (#, *), and other keys used for operating the mobile station.

The mobile station 10 may also have one or more sensors for sensing the ambient conditions of the mobile station. In this regard, the mobile station may include a positioning sensor such as, for example, a GPS sensor 64. Additionally, or alternatively, the positioning sensor can comprise, for example, a radio beacon triangulation sensor that determines the location of the wireless device by means of a network of radio beacons, base stations, or access points.

The mobile station 10 can further include memory, such as a subscriber identity module (SIM) 70, a removable user identity module (R-UIM) or the like, which typically stores information elements related to a mobile subscriber. In addition to the SIM, the mobile station can include other removable and/or fixed memory. In this regard, the mobile station can include volatile memory 72, such as volatile Random Access Memory (RAM) including a cache area for the temporary storage of data. The mobile station can also include other non-volatile memory 74, which can be embedded and/or may be removable. The non-volatile memory can additionally or alternatively comprise an EEPROM, flash memory or the like. The memories can store any of a number of software applications, instructions, pieces of information, and data, used by the mobile station to implement the functions of the mobile station.

According to embodiments of the present invention, memory, such as non-volatile memory 74, of the mobile station 10 can store the software and other data and/or settings necessary to implement one or more features. In this regard, each feature generally relates to a respective function that the mobile station is capable of performing upon execution of the software and/or use of the date and other settings. As used herein, however, the term feature shall not only refer to the associated functionality, but also the underlying software and other data and/or settings stored in memory. Although not necessary for the practice of the present invention, the various features may be stored in memory prior to delivery of the mobile station to an end user, such as during manufacture of the mobile station or at some other point in the distribution of the mobile station prior to delivery to the end user. Prior to enablement of the respective features as described below, the various features stored by memory are disabled and are therefore incapable of operation by the mobile station. The status of each feature may be defined in various manners, such as a flag associated with the respective feature that indicates whether the feature has been enabled or remains disabled. For purposes of illustration, but not of limitation, the non-volatile memory of FIG. 3 is shown to include Feature 1, Feature 2, . . . Feature n; each of which is associated with a respective flag that is capable of toggling between enabled (E) and disabled (D).

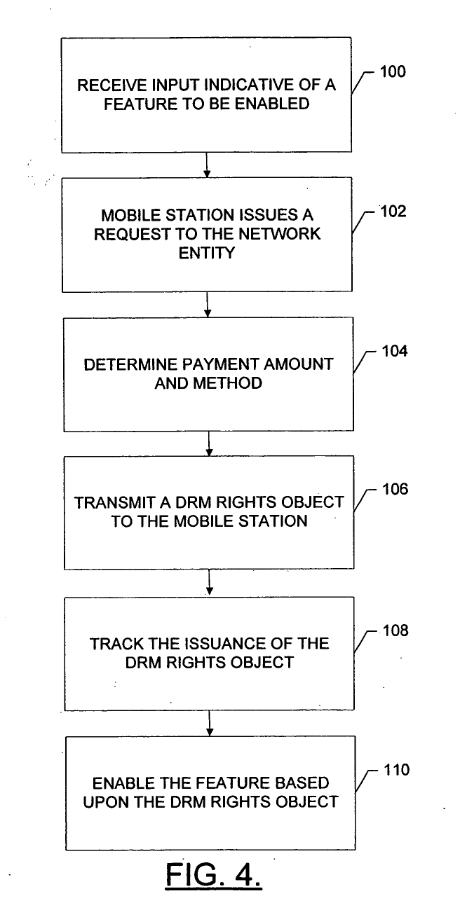

In order to enable a feature, a digital rights management (DRM) rights object must be provided to the mobile station 10, such as from a network entity, such as a DRM server 22. As shown in step 100 of FIG. 4, in order to initiate the process for obtaining a DRM rights object in order to enable a feature, the mobile station and, and one embodiment, the processing element 52 of the mobile station, receives an input from the end user, indicative of the particular feature that is currently disabled, but that is desired to be enabled. This input may be provided in various manners. For example, a user may provide the input via a user interface, such as a keypad 62 or a touch screen. For example, the processing element may be configured to display a list of features that are available, but currently disabled, and the user, in turn, can select one or more of the available features for enablement. Alternatively, the user may be considered to have requested enablement of a feature by attempting to access or otherwise employ a feature that has been determined by the processing element of the mobile station to be currently disabled. In exchange for enablement of the respective feature, the user typically must pay a fee in accordance with the overriding DRM policy to a third party, such as the owner of the intellectual property rights embodied by the respective feature. As such, the processing element may not only receive input indicative of a respective feature desired to be enabled, but may receive payment authorization from the user, such as the indication of a credit card or other account to be utilized for payment of the associated fee. Alternatively, the user could pay for the feature in other manners, such as by being billed for the enablement of the respective feature, such as by including an additional line item on the invoice presented to the end user by his or her service provider or carrier.

In response to the input indicative of the feature to be enabled, the processing element 52 is configured to issue a request to a network entity, such as a DRM server 22, for a DRM rights object for the respective feature. See step 102 of FIG. 4. Upon receipt of the request from the mobile station, the network entity and, in particular, the processing element 35 of the network entity typically determines the manner in which the third party, such as the owner of the underlying intellectual property rights, will be compensated for enablement of the feature, such as by charging the credit card or other account of the end user pursuant to an authorization provided by the user or by billing the end user, such as via the invoice issued by the service provider or carrier to the end user. See step 104. Additionally, the processing element of the network entity generally tracks the number of requests that are received for enablement of the various features for storage in memory 37 and for reporting purposes to the owners of the various intellectual property rights or otherwise. In response to the request from the mobile station for a DRM rights object for a respective feature and payment, as necessary, for the enablement of the respective feature, the processing element of the network entity transmits the DRM rights object for the respective feature to the mobile station. See step 106. Typically, the DRM rights object is encrypted, such as with the public key of the mobile station 10 such that other mobile stations or other types of digital devices that may receive the encrypted DRM rights object cannot make use of the DRM rights object in order to enable the same feature on the other devices. As noted above and as indicated in step 108, the processing element of the network server can note the transmission of the DRM rights object for the respective feature so as to track the number of instances in which the various features have been enabled for reporting purposes, such as to the owners of the intellectual property rights embodied in the respective features, or for other purposes.

Upon receipt of the DRM rights object and the decryption of the DRM rights object by the processing element 52 of the mobile station 10, such as with the private key of the mobile station, the respective feature is enabled and is thereafter operational by the mobile station. See step 110 of FIG. 4. The enablement of the respective feature may be noted by the processing element, such as by setting a corresponding flag in the memory 74 of the mobile station.

Various types of features can be subject to DRM and can be selectively enabled in accordance with embodiments of the present invention. For example, a mobile telephone may be capable of operating in accordance with both GSM and CDMA networks. For those mobile telephones sold primarily in a region serviced by GSM networks, the GSM features may be enabled and the CDMA features, such as the software and any other data and/or settings necessary for CDMA operation, may be disabled. Following delivery of the mobile telephone to the user, the user may plan to travel to a region serviced primarily by CDMA networks and, as such, may issue a request (accompanied by appropriate payment authorization) to the DRM server 22 for the CDMA features and, in particular, for the DRM rights object required to enable the CDMA features. Conversely, the mobile telephone of the foregoing embodiment may be sold, not in a region primarily serviced by GSM networks, but in a region primarily serviced by CDMA networks. In this instance, the CDMA features may be initially enabled and the GSM features may be initially disabled. If the user thereafter plans to travel to a region primarily supported by GSM networks, the user can request and purchase the DRM rights objects from the DRM server that are necessary to enable the GSM features. As such, a mobile telephone capable of operation in various types of networks can be manufactured and distributed with only those features enabled that are necessary or desired so as to reduce the initial cost of the mobile telephone by avoiding payment for features that are not desired.

As another example, a feature that is at least initially disabled may be an analog copy protection feature, such as the Macrovision analog copy protection feature, for analog “TV out” outputs. In this regard, if a user wishes to display his or her own photographs on a television set, copy protection is not required and therefore may remain disabled. However, in instances in which a mobile station 10 is capable for receiving protected content from a digital living network alliance (DLNA) home network through a digital transmission content protection (DTCP) link, the end user may be required to obtain the DRM rights object from the DRM server 22 in order to enable the copy protection feature in some situations. In this regard, if the end user only wishes to download the content to the mobile station for viewing while traveling, the end user still need not enable the copy protection feature. However, in the situation in which the end user wishes to display the DTCP protected content which has been downloaded to the mobile station on an analog television, the end user can request and receive the corresponding DRM rights object for the copy protection feature in accordance with one embodiment for the present invention so as to permit this type of display.

In another embodiment, a mobile station 10 may support multiple types of DRM, such as open mobile alliance (OMA) DRM and Windows Media DRM. Initially, if the user only wishes to utilize one type of DRM, such as Windows Media DRM, the user need not enable and therefore pay for the second type of DRM, such as OMA DRM. If the end user subsequently wishes to also utilize the second type of DRM, such as OMA DRM, the end user can direct the mobile station to issue a request and appropriate payment for the second type of DRM and, in return, can receive the DRM rights object from the DRM server 22 for the second type of DRM. After enabling the second type of DRM, the mobile station can then make use of both types of DRM as necessary. It is noted that the type of DRM that is initially enabled can serve as a “master” through which the rights for the other type of DRM can be purchased. In this regard, the processing element 52 of the mobile station may issue a request for the DRM rights object for the second type of DRM. This request for the DRM rights object for the second type of DRM is issued, however, in accordance with the first type of DRM. Similarly, the processing element 35 of the network entity 22 of this embodiment can receive the request for the DRM rights object for the second type of DRM and transmit the DRM rights object for the second type of DRM. Again, the processing element of the network entity can transmit the DRM rights object for the second type of DRM in accordance with the first type of DRM that is already enabled by the mobile station. Thereafter, the processing element of the mobile station can receive the DRM rights object for the second type of DRM, although the DRM rights object is provided in accordance with the first type of DRM.

Furthermore, a mobile station 10 may be embodied by a mobile television device which supports the digital video broadcasting (DVB) Internet Protocol DataCasting (IPDC) service purchase and protection system. Such a system may employ a traffic encryption layer that is encrypted in accordance with three possible standards, namely, the internet protocol security (IPsec) standard, the secure real-time protocol (SRTP) standard and the internet streaming media alliance cryptography (ISMAcryp) standard. The mobile television device may include three encryption features with each capable of providing the functionality to provide encryption/decryption in accordance with a different one of the standards. In one embodiment, however, only one of these features is enabled at the time of manufacture such that the traffic encryption layer is initially only encrypted in accordance with the enabled encryption feature. If the end user subsequently wishes to provide encryption in accordance with one of the other standards, the processing element 52 of the mobile television device may issue a request to the DRM server 22 for the DRM rights object associated with the desired encryption standard and, upon receipt of the DRM rights object, may thereafter enable the additional encryption standard in order to also provide encryption in accordance therewith.

In another example, a mobile station 10 may include hardware features that are disabled unless the features have been specifically enabled, such as by writing a predefined key to a respective register or memory location. In response to a request (and typically a payment), a DRM rights object including the key can be provided in order to enable the hardware features. The key may be specific to a particular mobile station, such as by depending upon the serial number or other identifier of the mobile station, so as to avoid interception and use of the key by other devices.

For example, in a mobile station 10 that includes one or more field programmable gate arrays (FPGAs), the actual FPGA configuration data file may be stored by memory 74 but encrypted in such a manner as to be unusable by the processing element 52 without having received an appropriate DRM rights object. Upon purchasing a DRM rights object, the configuration file may be decrypted and accessed. Similarly, various software routines or other components may be stored by memory, but encrypted and therefore unusable by the processing element at the time of delivery of the mobile station. After requesting and receiving a DRM rights object for a desired software component, the software component may be decrypted and thereafter utilized. While various examples of features that are subject to DRM and are selectively enabled in accordance with embodiments of the invention are provided above, a wide variety of other features can be similarly selectively enabled.

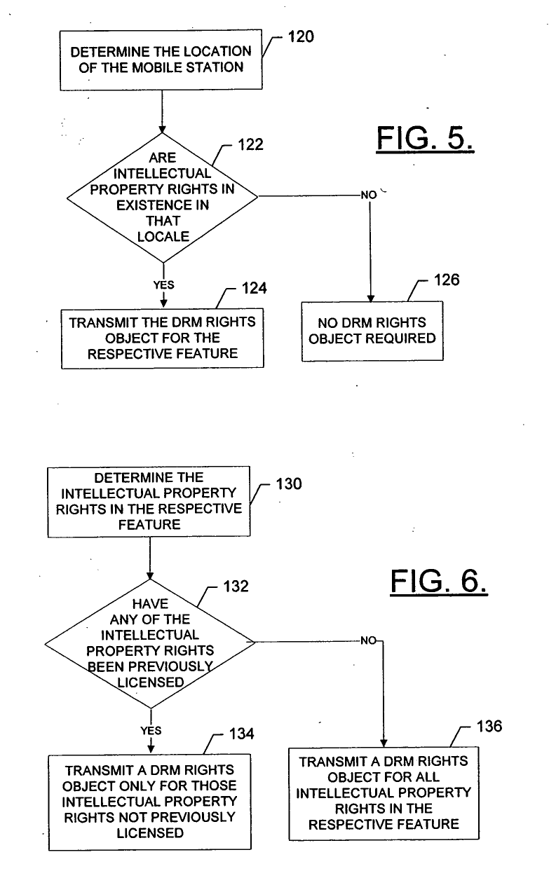

As described above, DRM policy sometimes dictates that a fee be paid by the end user to obtain a license or other rights in a respective feature, such as from the owner of the intellectual property rights embodied by the respective feature. In some instances, the intellectual property rights embodied in a respective feature are effective in one or more countries or regions, but ineffective or otherwise not in existence in other countries or regions. As shown in block 120 of FIG. 5, the mobile station 10 and/or the network entity 22 can determine the location of the mobile station, such as by means of a positioning sensor 64 as shown in FIG. 3 above. Based upon the location of the mobile station, the mobile station and/or the network entity can determine if the feature that is the subject of the request is protected by any intellectual property rights that are effective in the country or region in which the mobile station is currently located. See block 122. For example, the network entity can reference a database, which may be stored by memory 37 of the network entity or otherwise be accessible to the processing element 35 of the network entity, in order to identify the intellectual property rights embodied by each feature and the countries or other regions in which each intellectual property right is in effect. If the respective feature is not protected by intellectual property rights in the country or region in which the mobile station is currently located, the DRM rights object can be provided to the mobile station without payment of a fee. See block 126. Conversely, if the desired feature is protected by one or more intellectual property rights in the respective country in which the mobile station is located, the end user may be required to pay a fee to obtain the DRM rights object necessary to enable the respective feature. See block 124. As such, the mobile station and/or network entity of this embodiment can further reduce the costs for the end user by only charging fees for use in those countries in which the desired features are protected by one or more intellectual property rights. If a determination were made that the mobile station is not currently in a country or other region in which intellectual property rights exist for the requested feature and a DRM rights object is therefore provided to the mobile station without payment of the fee that would otherwise have been levied, the mobile station and/or the network entity can thereafter monitor the location the mobile station to determine if the mobile station has entered a country or other region in which intellectual property rights in the respective feature are in existence. If the mobile station and/or network determine that the mobile station has entered a country or other region in which intellectual property rights are in existence for the desired feature, the mobile station can again disable the desired feature and can prompt the user to pay the necessary fee for the DRM rights object required to re-enable the respective feature.

In addition or instead of being geographically limited, the intellectual property rights in a respective feature may be effective for a certain, limited period of time, but may lapse or otherwise become ineffective for a subsequent period of time. For example, patent rights typically expire twenty years following the filing date of the priority application, and perhaps earlier if the requisite fees are not paid. As such, based upon the current date, the mobile station 10 and/or the network entity 22 of one embodiment can determine if a feature that is the subject of the request is protected by any intellectual property rights that remain in effect from a temporal perspective. In this regard, the network entity can reference a database, which may be stored by memory 37 of the network entity or otherwise be accessible to the processing element 35 of the network entity, in order to identify the intellectual property rights embodied by each feature and the period of time for which each intellectual property right is in effect. If the respective feature is not protected by intellectual property rights at the present time, the DRM rights object can be provided to the mobile station without payment of a fee. Conversely, if the desired feature is currently protected by one or more intellectual property rights in the respective country in which the mobile station is located, the end user may be required to pay a fee to obtain the DRM rights object necessary to enable the respective feature. As such, the mobile station and/or network entity of this embodiment can further reduce the costs for the end user by only charging fees if one or more intellectual property rights remain in effect at the present time.

From a temporal perspective, the DRM rights objects that are provided in accordance with embodiments of the present invention may also be temporally limited. As such, a DRM rights object may be provided that selective enables a respective feature, but only for a predefined period of time. The processing element 52 of the mobile station 10 and/or the processing element 35 of the network entity 22 can determine when the predefined period of time has expired and again disable the respective feature such that the user would be required to again obtain a DRM rights object, such as by paying an additional fee, to again enable the feature. Thus, the provisioning of DRM rights object can be done on a subscription basis in which a user periodically pays for the DRM rights objects required to maintain use of the desired features.

Additionally, the same intellectual property right may be embodied in several different features. In this instance, an end user that has paid the fee for the intellectual property right in conjunction with a first feature generally need not again pay for that same intellectual property right in order to activate a second feature that embodies the same intellectual property right. As such, the processing element(s) of the mobile station 10 and/or the network entity 22 can track the intellectual property rights for which the mobile station has previously secured a license or otherwise paid the requisite fee and can store a list of such intellectual property rights in memory of the mobile station and/or the network entity. In response to each request for a DRM rights object to facilitate the enablement of another feature, the processing element(s) of the mobile station and/or the network entity can determine the intellectual property rights embodied in the additional feature in the manner described above and can then access memory to determine if any or all of those intellectual property rights have previously been licensed or otherwise had the fees paid by the mobile station, as shown in blocks 130 and 132 of FIG. 6. If so, the mobile station is generally not required to again pay to acquire the same intellectual property right and the DRM rights object for the additional feature can be issued without any additional payment or with some form of reduced payment for only those intellectual property rights embodied by the additional feature that have not yet been licensed or otherwise for which no payment has been made by the end user. See blocks 134 and 136. As such, the mobile station and corresponding network entity of this embodiment of the present invention may further conserve the expenditures of an end user by avoiding multiple payments for the same intellectual property rights even though the intellectual property rights are embodied in different features.

According to one exemplary aspect of the present invention, the functions performed by the mobile station 10 and/or the network entity 22 may be performed by various means, such as hardware and/or firmware, including those described above, alone and/or under control of a computer program product. The computer program product for performing one or more functions of exemplary embodiments of the present invention includes a computer-readable storage medium, such as the non-volatile storage medium, and software including computer-readable program code portions, such as a series of computer instructions, embodied in the computer-readable storage medium.

In this regard, FIGS. 4, 5 and 6 are flowcharts of methods, systems and program products according to exemplary embodiments of the present invention. It will be understood that each block or step of the flowchart, and combinations of blocks in the flowchart, can be implemented by various means, such as hardware, firmware and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
a processing element configured to receive input indicative of a respective disabled feature that is subject to digital rights management (DRM), to issue a request for a DRM rights object for the respective feature, to receive the DRM rights object for the respective feature and to enable the respective feature that was previously disabled in response to receipt of the DRM rights object.

2. An apparatus according to claim 1 wherein said processing element is configured to receive the input indicative of the respective disabled feature by receiving input indicative of an attempt to access the respective feature, and wherein said processing element is configured to issue the request for the DRM rights object automatically in response to receipt of input indicative of an attempt to access the respective feature.

3. An apparatus according to claim 1 wherein said processing element is configured to receive input indicative of the respective feature by receiving payment authorization from the user in exchange for the DRM rights object.

4. Astation apparatus according to claim 1 wherein said processing element is configured to support first and second types of DRM with the first type of DRM being currently enabled and the second type of DRM being currently disabled, wherein said processing element is configured to receive input indicative of the respective feature by receiving input indicative of the second type of DRM, to issue a request for a DRM rights object by issuing a request for a DRM rights object in accordance with the first type of DRM for the second type of DRM, to receive the DRM rights object for the respective feature by receiving the DRM rights object in accordance with the first type of DRM for the second type of DRM, and to enable the respective feature that was previously disabled by enabling the second type of DRM in response to receipt of the corresponding DRM rights object.

5. Astation apparatus according to claim 1 wherein said processing element is further configured to determine if intellectual property rights in the respective feature are in existence in the geographic location in which the apparatus is currently operating and, only if so, receiving the DRM rights object for the respective feature.

6. A station apparatus according to claim 1 wherein said processing element is further configured to determine any intellectual property rights embodied in the respective feature in response to receipt of input indicative of the respective feature and to determine if a DRM rights object has been previously received for each intellectual property right embodied in the respective feature and, only if not, to receive the DRM rights object for each intellectual property right in the respective feature for which a DRM rights object has not been previously received.

7. An apparatus according to claim 1, wherein the apparatus is embodied by a mobile station, and wherein the mobile station further comprises a memory device for storing at least one disabled feature that is subject to DRM.

8. A method comprising:
permitting operation of an apparatus that includes at least one disabled feature that is subject to digital rights management (DRM);
receiving input indicative of a respective disabled feature;
issuing a request for a DRM rights object for the respective feature;
receiving the DRM rights object for the respective feature; and
enabling the respective feature that was previously disabled in response to receipt of the DRM rights object.

9. A method according to claim 8 wherein receiving input indicative of the respective disabled feature comprises receiving input indicative of an attempt to access the respective feature, and wherein issuing the request for the DRM rights object comprises automatically issuing the request in response to receipt of input indicative of an attempt to access the respective feature.

10. A method according to claim 8 wherein receiving input indicative of the respective feature comprises receiving payment authorization from the user in exchange for the DRM rights object.

11. A method according to claim 7 wherein the apparatus supports first and second types of DRM with the first type of DRM being currently enabled and the second type of DRM being currently disabled, wherein receiving input indicative of the respective feature comprises receiving input indicative of the second type of DRM, wherein issuing a request for a DRM rights object comprises issuing a request for a DRM rights object in accordance with the first type of DRM for the second type of DRM, wherein receiving the DRM rights object for the respective feature comprises receiving the DRM rights object in accordance with the first type of DRM for the second type of DRM, and wherein enabling the respective feature that was previously disabled comprises enabling the second type of DRM in response to receipt of the corresponding DRM rights object.

12. A method according to claim 8 further comprising determining if intellectual property rights in the respective feature are in existence in the geographic location in which the apparatus is currently operating and, only if so, receiving the DRM rights object for the respective feature.

13. A method according to claim 8 further comprising:
determining any intellectual property rights embodied in the respective feature in response to receipt of input indicative of the respective feature; and
determining if a DRM rights object has been previously received for each intellectual property right embodied in the respective feature and, only if not, receiving the DRM rights object for each intellectual property right in the respective feature for which a DRM rights object has not been previously received.

14. A method according to claim 8 wherein enabling the respective feature comprises enabling the respective feature for a predetermined period of time defined by the DRM rights object.

15. A computer program product comprising at least one computer-readable storage medium having computer-readable program code portions stored therein, the computer-readable program code portions comprising:
a first executable portion for permitting operation of an apparatus that includes at least one disabled feature that is subject to digital rights management (DRM);
a second executable portion for receiving input indicative of a respective disabled feature;
a third executable portion for issuing a request for a DRM rights object for the respective feature;
a fourth executable portion for receiving the DRM rights object for the respective feature; and
a fifth executable portion for enabling the respective feature that was previously disabled in response to receipt of the DRM rights object.

16. A computer program product according to claim 15 wherein the second executable portion is configured to receive input indicative of an attempt to access the respective feature, and wherein the third executable portion is configured to issue the request for the DRM rights object comprises automatically issuing the request in response to receipt of input indicative of an attempt to access the respective feature.

17. A computer program product according to claim 15 wherein the second executable portion is configured to receive payment authorization from the user in exchange for the DRM rights object.

18. A computer program product according to claim 15 wherein the apparatus supports first and second types of DRM with the first type of DRM being currently enabled and the second type of DRM being currently disabled, wherein the second executable portion is configured to receive input indicative of the second type of DRM, wherein the third executable portion is configured to issue a request for a DRM rights object in accordance with the first type of DRM for the second type of DRM, wherein the fourth executable portion is configured to receive the DRM rights object in accordance with the first type of DRM for the second type of DRM, and wherein the fifth executable portion is configured to enable the second type of DRM in response to receipt of the corresponding DRM rights object.

19. A computer program product according to claim 15 further comprising a seventh executable portion for determining if intellectual property rights in the respective feature are in existence in the geographic location in which the apparatus is currently operating and, only if so, receiving the DRM rights object for the respective feature with the fourth executable portion.

20. A computer program product according to claim 15 further comprising:
a sixth executable portion for determining any intellectual property rights embodied in the respective feature in response to receipt of input indicative of the respective feature by the second executable portion; and
a seventh executable portion for determining if a DRM rights object has been previously received for each intellectual property right embodied in the respective feature and, only if not, receiving the DRM rights object for each intellectual property right in the respective feature for which a DRM rights object has not been previously received.

21. A computer program product according to claim 15 wherein the fifth executable portion is further configured to enable the respective feature for a predetermined period of time defined by the DRM rights object.

22. An apparatus comprising:
means for receiving input indicative of a respective feature that is locally stored but that is disabled and subject to digital rights management (DRM);
means for issuing a request to a network entity for a DRM rights object for the respective feature;
means for receiving the DRM rights object from the network entity for the respective feature; and
means for enabling the respective feature that was previously disabled in response to receipt of the DRM rights object.

23. A network entity comprising:
a processing element configured to receive a request from astation apparatus for a digital rights management (DRM) rights object for a respective feature that is stored locally by the apparatus but that is currently disabled, to transmit the DRM rights object for the respective feature to the apparatus to permit enablement of the respective feature, and to note transmission of the DRM rights object for the respective feature.

24. A network entity according to claim 23 wherein said processing element is further configured to receive the request by receiving payment authorization from the apparatus in exchange for the DRM rights object for the respective feature.

25. A network entity according to claim 23 wherein the apparatus supports first and second types of DRM with the first type of DRM being currently enabled and the second type of DRM being currently disabled, wherein said processing element is configured to receive the request by receiving a request for the DRM rights object for the second type of DRM, and wherein said processing element is configured to transmit the DRM rights object by transmitting the DRM rights object in accordance with the first type of DRM for the second type of DRM.

26. A network entity according to claim 23 wherein said processing element is further configured to determine if intellectual property rights in the respective feature are in existence in the geographic location in which the apparatus is currently operating and, only if so, to transmit the DRM rights object for the respective feature.

27. A network entity according to claim 23 wherein said processing element is further configured to determine any intellectual property rights embodied in the respective feature in response to receipt of the request and to determine if a DRM rights object has been previously transmitted to the apparatus for each intellectual property right embodied in the respective feature and, only if not, to transmit the DRM rights object for each intellectual property right in the respective feature for which a DRM rights object has not been previously transmitted.

28. A method comprising:
receiving a request from an apparatus for a digital rights management (DRM) rights object for a respective feature that is stored locally by the apparatus but that is currently disabled;
transmitting the DRM rights object for the respective feature to the apparatus to permit enablement of the respective feature; and
noting transmission of the DRM rights object for the respective feature.

29. A method according to claim 28 wherein receiving the request comprises receiving payment authorization from the apparatus in exchange for the DRM rights object for the respective feature.

30. A method according to claim 28 wherein the apparatus supports first and second types of DRM with the first type of DRM being currently enabled and the second type of DRM being currently disabled, wherein receiving the request comprises receiving a request for the DRM rights object for the second type of DRM, and wherein transmitting the DRM rights object comprises transmitting the DRM rights object in accordance with the first type of DRM for the second type of DRM.

31. A method according to claim 28 further comprising determining if intellectual property rights in the respective feature are in existence in the geographic location in which the apparatus is currently operating and, only if so, transmitting the DRM rights object for the respective feature.

32. A method according to claim 28 further comprising:
determining any intellectual property rights embodied in the respective feature in response to receipt of the request; and
determining if a DRM rights object has been previously transmitted to the apparatus for each intellectual property right embodied in the respective feature and, only if not, transmitting the DRM rights object for each intellectual property right in the respective feature for which a DRM rights object has not been previously transmitted.

33. A method according to claim 28 wherein transmitting the DRM rights object comprises transmitting a DRM rights object that is effective to enable the respective feature for a predetermined period of time.
